(19) United States
(12) Patent Application Publication
(10) Pub. No.: US 2026/0025858 A1
(43) Pub. Date: Jan. 22, 2026

(54) ASSOCIATION PROCEDURES FOR EMERGENCY COMMUNICATION IN WIRELESS NETWORK

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Allen, TX (US); Vishnu Vardhan Ratnam, Frisco, TX (US); Yue Qi, Plano, TX (US); Bilal Sadiq, Plano, TX (US)

(21) Appl. No.: 19/249,697

(22) Filed: Jun. 25, 2025

Related U.S. Application Data
(60) Provisional application No. 63/674,041, filed on Jul. 22, 2024.

(51) Int. Cl. H04W 74/08; H04W 4/90; H04W 8/00; H04W 12/06; H04W 60/04

(52) U.S. Cl. CPC H04W 74/0875; H04W 4/90; H04W 8/005; H04W 12/06; H04W 60/04

(57) ABSTRACT

An access point (AP) for facilitating communication in a wireless network. The AP has a memory and a processor coupled to the memory. The AP transmits, to a plurality of stations (STAs), a frame including an enhanced distributed channel access (EDCA) parameter set that provides prioritized access to a wireless medium for STAs that support emergency preparedness communication services (EPCS). The AP receives, from a STA that supports EPCS, an association request frame based on the EDCA parameter set. The AP transmits, to the STA, an association response frame in response to the association request frame.

### CROSS REFERENCE TO RELATED APPLICATION

This application claims benefit of U.S. Provisional Application No. 63/674,041, entitled “ASSOCIATION PROCEDURES FOR EPCS OPERATION IN NEXT GENERATION WLANS,” filed on Jul. 22, 2024, in the United States Patent and Trademark Office, the entire contents of which is hereby incorporated by reference.

### TECHNICAL FIELD

This disclosure relates generally to a wireless communication system, and more particularly to, for example, but not limited to, emergency communication system operation in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

This disclosure may be directed to improvements to a wireless communications system, more particularly to provide priority access during association, high priority response and processing procedure, a fast discovery procedure, special time for emergency preparedness communication services (EPCS) device management frame transmission, a modified probe response procedure for EPCS management frame transmission, and a procedure for creation of special resource units for EPCS management frame transmission.

An aspect of the disclosure provides an access point (AP) device for facilitating communication in a wireless network. The AP device comprises a memory and a processor coupled to the memory. The processor is configured to cause transmitting, to a plurality of station (STA) devices, a frame including an enhanced distributed channel access (EDCA) parameter set that provides prioritized access to a wireless medium for STA devices that support EPCS. The processor is further configured to cause receiving, from a STA device that supports EPCS, an association request frame transmitted based on the EDCA parameter set. The processor is further configured to cause transmitting, to the STA device, an association response frame in response to the association request frame.

In an embodiment, the EDCA parameter set provides higher priority for the STA device to transmit the association request frame, relative to a STA device that does not support EPCS.

In an embodiment, the association response frame is transmitted with higher priority than an association response frame transmitted to a STA device that does not support EPCS.

In an embodiment, the processor is further configured to cause prior to the transmitting the frame including the EDCA parameter set, receiving, from the STA device, a probe request frame including information indicating that the STA device supports EPCS. The processor is further configured to cause the frame including the EDCA parameter set is a probe response frame.

In an embodiment, the processor is further configured to cause receiving, from the STA device, an authentication request frame transmitted based on the EDCA parameter set. The processor is further configured to cause transmitting, to the STA device, an authentication response frame in response to the authentication request frame.

In an embodiment, the processor is further configured to cause transmitting, to the STA device, a disassociation frame based on a determination that the STA device does not support EPCS.

In an embodiment, the processor is further configured to cause transmitting, to the plurality of STA devices, a discovery frame to facilitate STA devices that support EPCS in discovering the AP device.

In an embodiment, the frame including the EDCA parameter set includes information that identifies a time interval during which only STA devices that support EPCS are capable of transmitting a frame.

An aspect of the disclosure provides an STA device for facilitating communication in a wireless network. The STA comprises a memory and a processor coupled to the memory. The processor is configured to cause receiving, from an AP device, a frame including an EDCA parameter set that provides prioritized access to a wireless medium for STA devices that support EPCS. The processor is further configured to cause transmitting, to the AP device, an association request frame based on the EDCA parameter set. The processor is further configured to cause receiving, from the AP device, an association response frame in response to the association request frame.

In an embodiment, the EDCA parameter set provides higher priority for the STA device to transmit the association request frame, relative to a STA device that does not support EPCS.

In an embodiment, the processor is further configured to cause prior to the receiving the frame including the EDCA parameter set, transmitting, to the AP device, a probe request frame including information indicating that the STA device supports EPCS. The processor is further configured to cause the frame including the EDCA parameter set is a probe response frame.

In an embodiment, the processor is further configured to cause transmitting, to the AP device, an authentication request frame based on the EDCA parameter set. The processor is further configured to cause receiving, from the AP device, an authentication response frame in response to the authentication request frame.

In an embodiment, the processor is further configured to cause receiving, from the AP device, a disassociation frame based on a determination that the STA device does not support EPCS.

In an embodiment, the processor is further configured to cause receiving, from the AP device, a discovery frame to facilitate the STA device in discovering the AP device.

An aspect of the disclosure provides a method performed by an AP device. The method comprises transmitting, to a plurality of STA devices, a frame including an EDCA parameter set that provides prioritized access to a wireless medium for STA devices that support EPCS. The method further comprises receiving, from a STA device that supports EPCS, an association request frame transmitted based on the EDCA parameter set. The method further comprises transmitting, to the STA device, an association response frame in response to the association request frame.

In an embodiment, the EDCA parameter set provides higher priority for the STA device to transmit the association request frame, relative to a STA device that does not support EPCS.

In an embodiment, the association response frame is transmitted with higher priority than an association response frame transmitted to a STA device that does not support EPCS.

In an embodiment, the method further comprises prior to the transmitting the frame including the EDCA parameter set, receiving, from the STA device, a probe request frame including information indicating that the STA device supports EPCS. The method further comprises the frame including the EDCA parameter set is a probe response frame.

In an embodiment, the method further comprises receiving, from the STA device, an authentication request frame transmitted based on the EDCA parameter set. The method further comprises transmitting, to the STA device, an authentication response frame in response to the authentication request frame.

In an embodiment, the method further comprises transmitting, to the STA device, a disassociation frame based on a determination that the STA device does not support EPCS.

### BRIEF DESCRIPTION OF THE DRAWINGS

FIG. 1 illustrates an example of a wireless network in accordance with an embodiment of this disclosure.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example network in accordance with an embodiment.

FIG. 5 shows an example of priority access during association in accordance with an embodiment.

FIG. 6 shows an example AP discovery in accordance with an embodiment.

FIG. 7 shows an example probe request and response procedure in accordance with an embodiment.

FIG. 8 shows an example process for association with priority access in accordance with an embodiment.

FIG. 9 shows another example process for association with priority access in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The present disclosure relates to a wireless communication system, and more particularly, to a Wireless Local Area Network (WLAN) technology. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique MIMO has been adopted in several wireless communications standards such 802.11ac, 802.11ax etc.

Before undertaking the detailed description below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

Figures discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

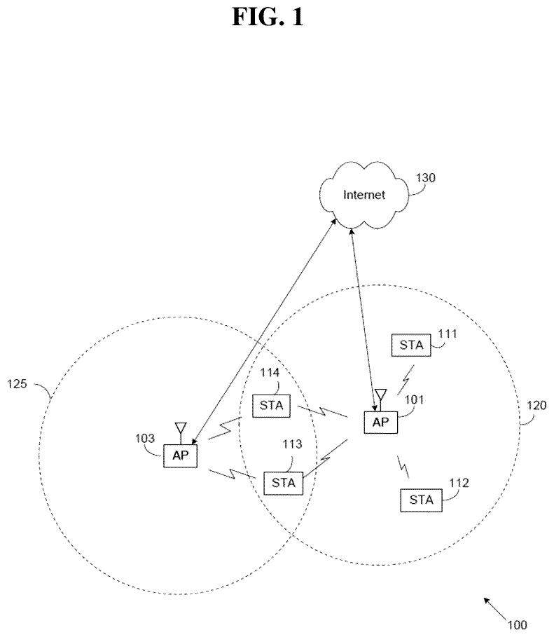

FIG. 1 shows an example wireless network 100 according to this disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WiFi or other WLAN communication techniques.

Depending on the network type, other well-known terms may be used instead of “access point” or “AP,” such as “router” or “gateway.” For the sake of convenience, the term “AP” is used in this patent document to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this patent document to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for management of multiple user (MU)-MIMO and orthogonal frequency division multiple access (OFDMA) channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

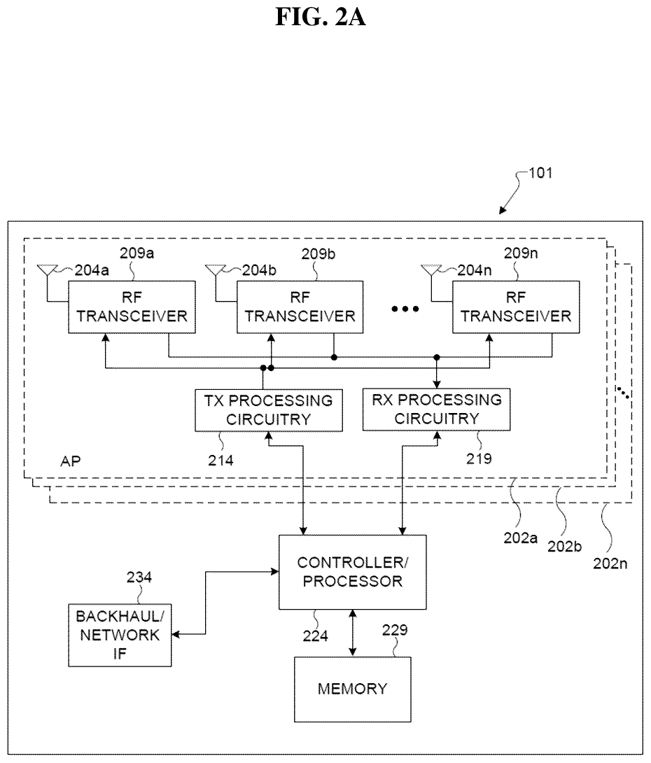

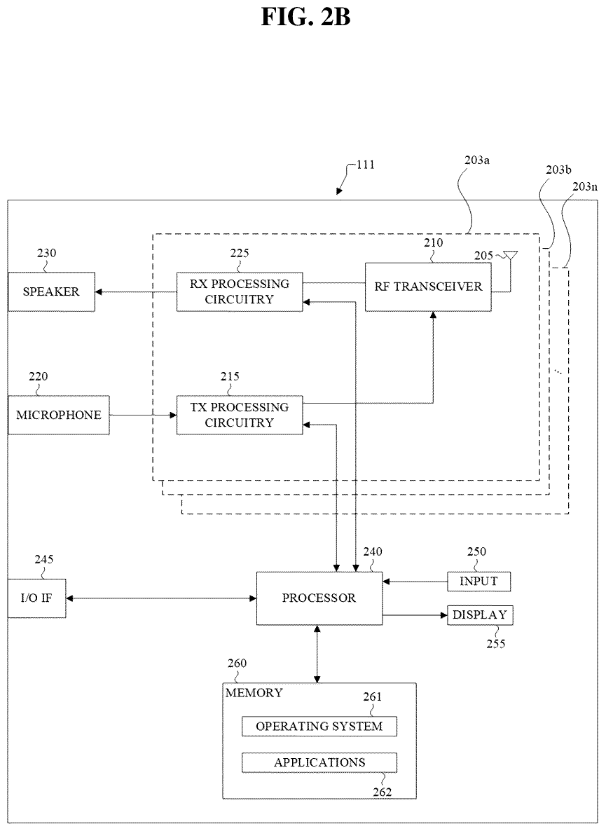

FIG. 2A shows an example AP 101 according to this disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

As shown in FIG. 2A, the AP 101 includes multiple antennas 204a-204n, multiple RF transceivers 209a-209n, transmit (TX) processing circuitry 214, and receive (RX) processing circuitry 219. The AP 101 also includes a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions.

For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of downlink (DL) MU-MIMO and OFDMA in the same transmit opportunity. In some embodiments, the controller/processor 224 includes at least one microprocessor or microcontroller. The controller/processor 224 is also capable of executing programs and other processes resident in the memory 229, such as an operating system (OS). The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A shows one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. As another particular example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

FIG. 2B shows an example STA 111 according to this disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of this disclosure to any particular implementation of a STA.

As shown in FIG. 2B, the STA 111 includes antenna(s) 205, a radio frequency (RF) transceiver 210, TX processing circuitry 215, a microphone 220, and receive (RX) processing circuitry 225. The STA 111 also includes a speaker 230, a controller/processor 240, an input/output (I/O) interface (IF) 245, a touchscreen 250, a display 255, and a memory 260. The memory 260 includes an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to provide management of channel sounding procedures in WLANs. In some embodiments, the controller/processor 240 includes at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The main controller/processor 240 is also coupled to the I/O interface 245, which provides STA 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the STA 111 can use the touchscreen 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B shows the STA 111 configured as a mobile telephone or smartphone, STAs could be configured to operate as other types of mobile or stationary devices.

As shown in FIG. 2B, in some embodiments, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

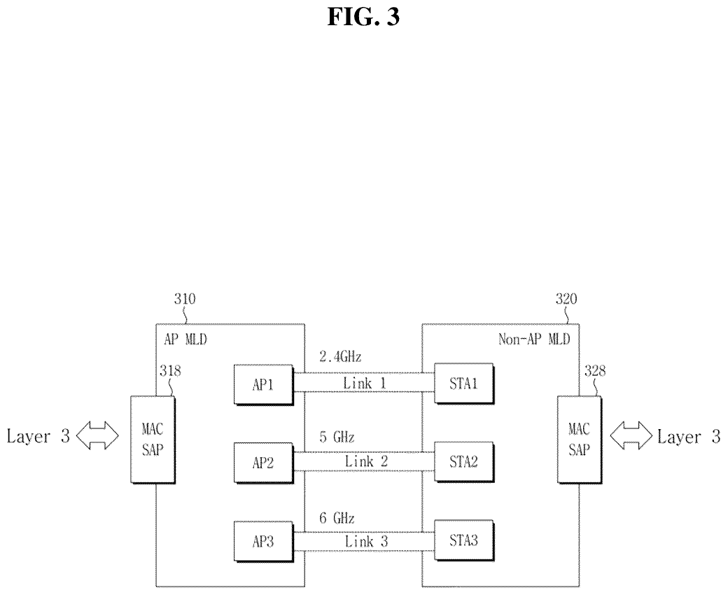

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA I may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” iii) IEEE P802.11be/D6.0, “Wireless LAN Medium Access Control (MAC) and Physical Layer (PHY) Specifications.”

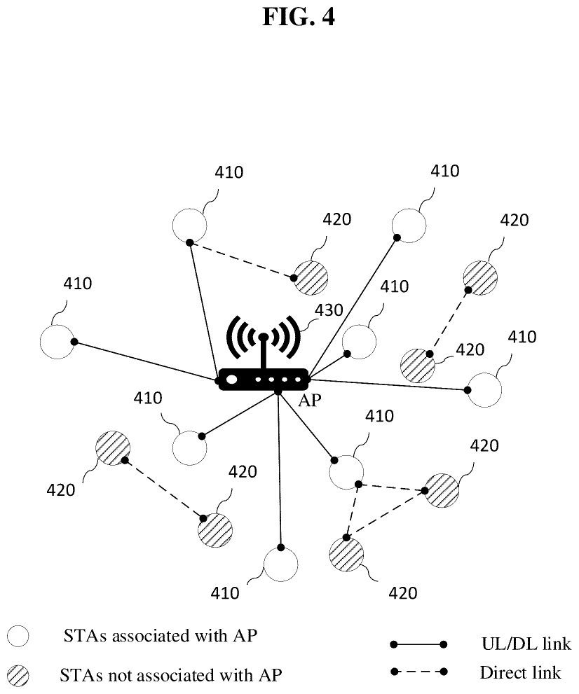

FIG. 4 shows an example network in accordance with an embodiment. The network depicted in FIG. 4 is for explanatory and illustration purposes. FIG. 4 does not limit the scope of this disclosure to any particular implementation.

In FIG. 4, a plurality of STAs 410 may be non-AP STAs associated with AP 430, and a plurality of STAs 420 may be non-AP STAs which are not associated with AP 430. Additionally, solid lines between STAs represent uplink or downlink with AP 430, while the dashed lines between STAs represent a direct link between STAs.

Emergency telecommunication services have been implemented in a number of countries with the objective of providing prioritized access in the event of disasters or emergencies. Examples of such telecommunication services in the United States includes government emergency telecommunication service (GETS), wireless priority service (WPS), next generation network priority services (NGN priority services) and telecommunications service priority (TSP). Such services have also been implemented in other countries. Examples of such services outside of the United States include blue light mobile service in Belgium, mobile telecommunications privileged access scheme in Great Britain and disaster priority telephone in Japan. Typically, such services are subscription based, operator controlled, enabled through global standards and are offered over commercial network infrastructure.

In recent times there has been a growing need for such services over Wi-Fi networks. In IEEE 802.11be, Emergency Preparedness Communication Services (EPCS) has been introduced with the goal of providing prioritized access to certain authorized users. As a part of this service, a user that has associated with an AP can be authorized by the AP to take advantage of EPCS service. Once authorized, the user can use an enhanced distributed channel access (EDCA) parameter set with values for parameters such as CW(contention window)min[AC(access category)], CWmax[AC] and AIFSN(arbitration interframe space number)[AC], which are different from those for other STAs associated with the same AP. This enhanced EDCA parameter set may be referred to as a prioritized EDCA. With this prioritized EDCA parameter set, a non-AP MLD that is authorized by the AP benefits from prioritized access as it can capture the channel faster compared to other users in the network. After EPCS is disabled, the non-AP MLD can update its EDCA parameter set to match that of other non-EPCS users in the network.

Currently, legacy EPCS operation only enables a device to obtain priority access to the wireless medium to transmit data frames. This priority access is useful for enabling EPCS traffic to avoid the congestion on the wireless medium by reducing their overall channel access period. However, initial link setup procedure, such as an association or authentication request, cannot take advantage of the priority access. Procedures in which EPCS authorized devices or devices with EPCS enabled, such as EPCS devices, can take advantage of priority access when setting up links with an AP are needed.

In an embodiment, an EPCS device can obtain priority access during association. An AP can advertise enhanced operation parameters, such as EDCA or MU-EDCA, in beacons the AP transmits for EPCS devices. These parameters can enable EPCS devices to obtain priority access to the wireless medium when transmitting management frames such as an association request or an authentication request.

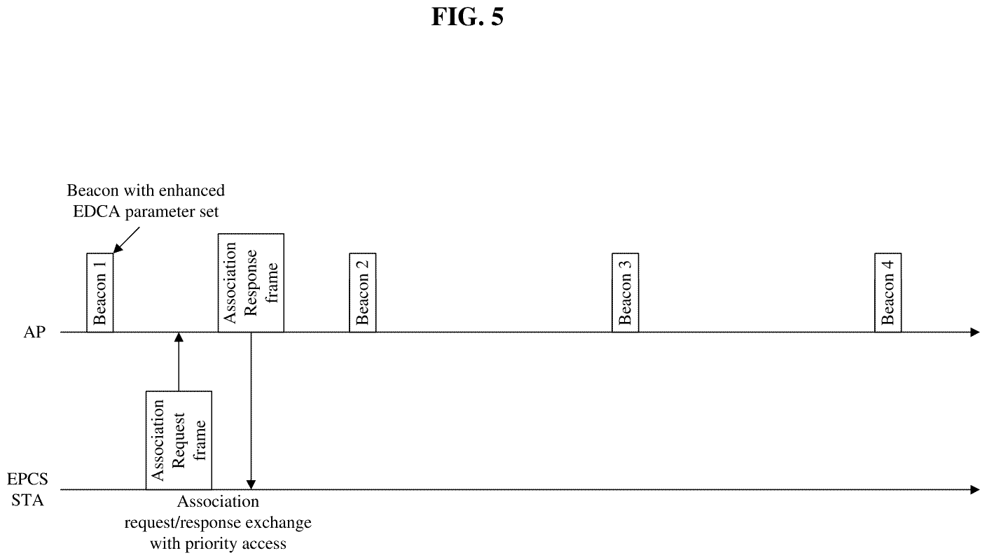

FIG. 5 shows an example of priority access during association in accordance with an embodiment. The example depicted in FIG. 5 is for explanatory and illustration purposes. FIG. 5 does not limit the scope of this disclosure to any particular implementation.

Referring to FIG. 5, an AP and an EPCS STA are not associated with one another. The EPCS STA has EPCS traffic. The AP transmits a Beacon 1 frame. The Beacon 1 frame includes a prioritized EDCA parameter set. The prioritized EDCA parameter set provides priority access. The EPCS STA receives, from the AP, the Beacon 1 frame. Subsequently, the EPCS STA transmits, to the AP, an Association Request frame based on the prioritized EDCA parameter set. In response, the AP transmits, to the EPCS STA, an Association Response frame based on the prioritized EDCA parameter set, accepting the request. The AP continues to transmit a Beacon 2 frame, a Beacon 3 frame and a Beacon 4 frame. The Beacon 2 frame, the Beacon 3 frame and the Beacon 4 frame include a prioritized EDCA parameter set providing priority access.

In an embodiment, an AP can provide high priority to processing and response of management frames received from EPCS devices. For example, an AP can provide high priority to process an authentication request from an EPCS device if the AP receives authentication requests from the EPCS device and a non-EPCS device.

In an embodiment, an AP can provide high priority to transmitting management response frames to EPCS devices. For example, an AP can perform retransmission of a (Re)association Response frame to an EPCS device before the AP performs retransmission of a (Re)association Response frame to a non-EPCS device if the AP has to perform the retransmission to the EPCS device and the non-EPCS device.

In an embodiment, during roaming, an AP may provide higher priority to a roaming related frame, such as a link setup request or a (Re)association request, from an EPCS device over a roaming related frame from a non EPCS device.

In an embodiment, an AP can transmit an additional discovery message during the interval between beacon transmissions to facilitate EPCS devices in discovering the AP faster. For example, the AP can transmit fast initial link setup (FILS) discovery frames to enable EPCS devices to discover the AP faster. Such discovery messages can be transmitted every 20 milliseconds as a opposed to a beacon which is transmitted every 100 milliseconds.

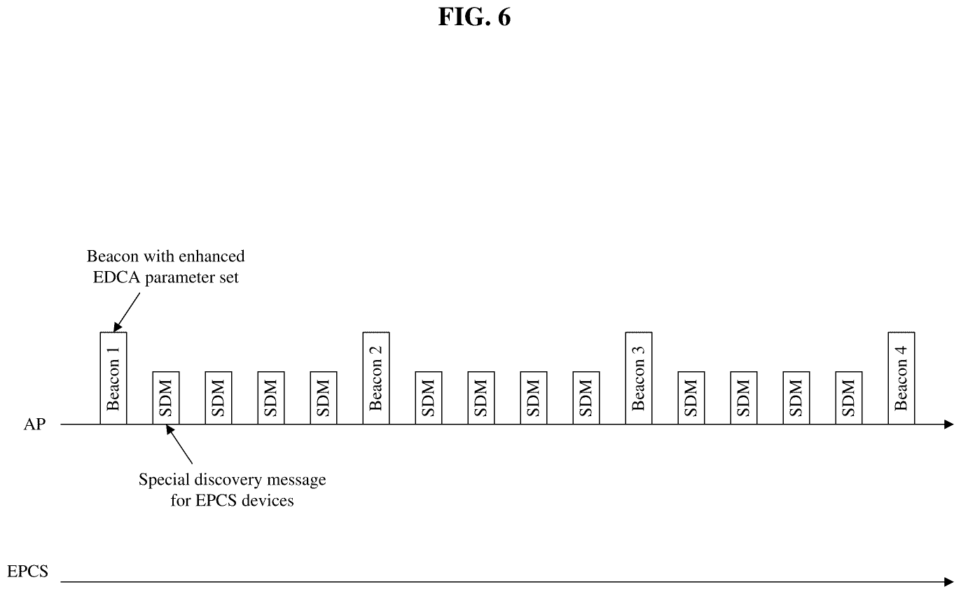

FIG. 6 shows an example of AP discovery in accordance with an embodiment. The example depicted in FIG. 6 is for explanatory and illustration purposes. FIG. 6 does not limit the scope of this disclosure to any particular implementation.

Referring to FIG. 6, an AP and an EPCS STA are not associated with one another. The EPCS STA is unaware of the AP. The AP transmits a Beacon 1 frame. The Beacon 1 frame includes a prioritized EDCA parameter set. The EPCS STA does not receive the Beacon 1 frame. Subsequently, the AP periodically transmits a special discovery message (SDM) during the interval between the Beacon 1 frame and a Beacon 2 frame. The AP transmits four SDMs during the interval between the Beacon 1 frame and the Beacon 2 frame. The EPCS STA receives at least one of the four SDMs transmitted during the interval between the Beacon 1 frame and the Beacon 2 frame. After receiving at least one of the four SDMs, the EPCS STA is now aware of the AP. The EPCS STA and the AP are capable of performing an association request/response exchange earlier than if the EPCS STA had to wait until the AP transmitted the Beacon 2 frame. Subsequently, the AP transmits the Beacon 2 frame. The Beacon 2 frame includes a prioritized EDCA parameter set. Subsequently, the AP periodically transmits an SDM during the interval between the Beacon 2 frame and a Beacon 3 frame. The AP transmits four SDMs during the interval between the Beacon 2 frame and the Beacon 3 frame. Subsequently, the AP transmits the Beacon 3 frame. The Beacon 3 frame includes a prioritized EDCA parameter set. Subsequently the AP periodically transmits an SDM during the interval between the Beacon 3 frame and a Beacon 4 frame. The AP transmits four SDMs during the interval between the Beacon 3 frame and the Beacon 4 frame. Subsequently, the AP transmits the Beacon 4 frame. The Beacon 4 frame includes a prioritized EDCA parameter set.

In an embodiment, an AP can setup a special time interval, such as a target wake time (TWT) interval, during which EPCS devices can transmit management frames. For example, the AP can setup a special TWT like interval in which a service period (SP) can be dedicated to EPCS device transmissions and a doze state can be dedicated to non-EPCS device transmissions.

In an embodiment, an EPCS device can indicate an EPCS state of the EPCS device, such as the EPCS device if it is a device with EPCS enabled or disabled, to the AP when transmitting an initial management frame prior to association, such as a probe request. The AP can transmit, to the EPCS device, a probe response in which the AP provides the EPCS device with a temporary prioritized EDCA parameter set. The EPCS device can use the temporary prioritized EDCA parameter set to associate with the AP. The AP can verify the EPCS device's EPCS authorization. The EPCS device can also request that verification of EPCS authorization be performed by the AP.

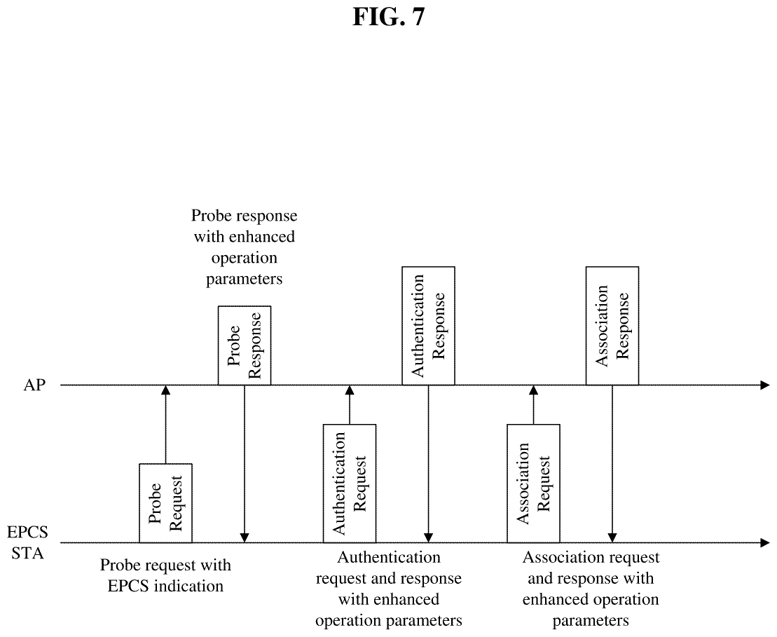

FIG. 7 shows an example probe request and response procedure in accordance with an embodiment. The example depicted in FIG. 7 is for explanatory and illustration purposes. FIG. 7 does not limit the scope of this disclosure to any particular implementation.

Referring to FIG. 7, an AP and an EPCS STA are not associated with one another. The EPCS STA transmits, to the AP, a Probe Request frame indicating that the EPCS STA has EPCS enabled. In response, the AP transmits a Probe Response frame including enhanced operation parameters, such as in a temporary prioritized EDCA parameter set. Subsequently, the EPCS STA transmits, to the AP, an Authentication Request frame requesting that the AP authenticate that the EPCS STA has EPCS enabled. The Authentication Request frame is transmitted using the enhanced operation parameters for priority access. In response, the AP transmits, to the EPCS STA, an Authentication Response frame indicating that the EPCS STA is authenticated as having EPCS enabled. The Authentication Response frame is transmitted using the enhanced operation parameters for priority access. Subsequently, the EPCS STA transmits, to the AP, an Association Request frame requesting association with the AP. The Association Request frame is transmitted using the enhanced operation parameters for priority access. In response, the AP transmits, to the EPCS STA, an Association Response frame accepting the association request. The Association Response frame is transmitted using the enhanced operation parameters for priority access.

In an embodiment, an AP can penalize non-EPCS STAs that abuse the AP's providing of temporary prioritized EDCA parameter sets. For example, the AP can disassociate with non-EPCS devices that requested priority access during association procedure and which the AP later identified as being not authorized for EPCS.

In an embodiment, an AP can allocate resource units (RUs) for un-associated EPCS devices. The RUs can be assigned to special address identifiers (AIDs) that can be used only by EPCS devices for transmission of frames.

The embodiments listed above may also be applied to a multi-link operation and are not limited to a single link. For example, an AP that transmits a beacon including a prioritized EDCA parameter set that can indicate prioritized EDCA parameter sets for other links of the EPCS device.

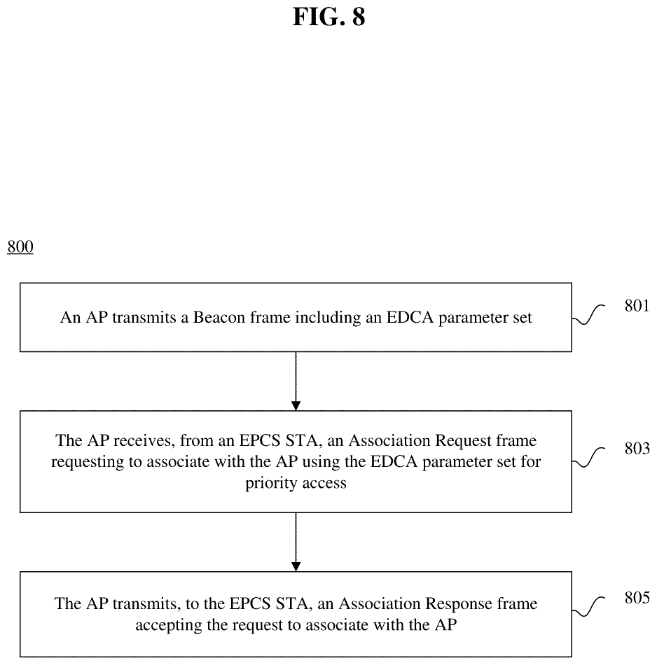

FIG. 8 shows an example process for association with priority access in accordance with an embodiment. The process depicted in FIG. 8 is for explanatory and illustration purposes. FIG. 8 does not limit the scope of this disclosure to any particular implementation.

Referring to FIG. 8, the process 800 begins at operation 801. In operation 801, an AP transmits a Beacon frame including a prioritized EDCA parameter set. The AP may transmit another Beacon frame an interval after the transmission of the Beacon frame. The AP may periodically transmit special discovery messages during the interval after the transmission of the Beacon frame.

In operation 803, the AP receives, from the EPCS STA, an Association Request frame requesting to associate with the AP using the prioritized EDCA parameter set for priority access.

In operation 805, the AP transmits, to the EPCS STA, an Association Response frame accepting the request to associate with the AP. The AP may use the prioritized EDCA parameter set to transmit the Association Response frame with priority access.

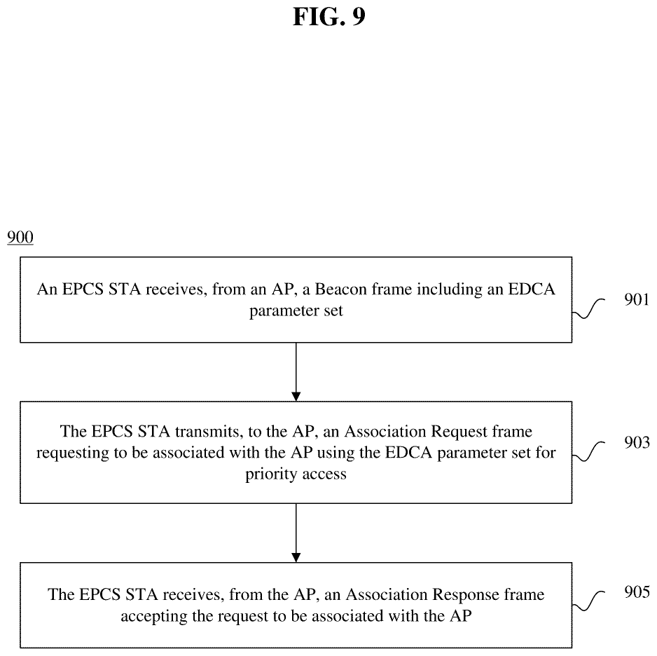

FIG. 9 shows another example process for association with priority access in accordance with an embodiment. The process depicted in FIG. 9 is for explanatory and illustration purposes. FIG. 9 does not limit the scope of this disclosure to any particular implementation.

Referring to FIG. 9, the process 900 begins at operation 901. In operation 901, an EPCS STA receives, from an AP, a Beacon frame including a prioritized EDCA parameter set. If the EPCS STA has not received a Beacon frame from the AP, the EPCS STA may transmit, to the AP, a Probe Request frame indicating EPCS capability. If the EPCS STA transmitted a Probe Request frame to the AP, then the EPCS STA may receive a Probe Response frame including the prioritized EDCA parameter set.

In operation 903, the EPCS STA transmits, to the AP, an Association Request frame requesting to be associated with the AP using the prioritized EDCA parameter set for priority access.

In operation 905, the EPCS receives, from the AP, an Association Response frame accepting the request to be associated with the AP.

The disclosure provides mechanisms and protocols for utilization of priority access for link setup procedures. EPCS STAs that use priority access for setup link procedures can avoid congestion on a wireless medium by reducing the EPCS STA's overall channel access period.

The various illustrative blocks, units, modules, components, methods, operations, instructions, items, and algorithms may be implemented or performed with processing circuitry.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the subject technology. The term “exemplary” is used to mean serving as an example or illustration. To the extent that the term “include,” “have,” “carry,” “contain,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, the description may provide illustrative examples and the various features may be grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The embodiments are provided solely as examples for understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of this invention.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An access point (AP) device for facilitating communication in a wireless network, comprising:
a memory; and
a processor coupled to the memory, the processor configured to cause:
transmitting, to a plurality of station (STA) devices, a frame including an enhanced distributed channel access (EDCA) parameter set that provides prioritized access to a wireless medium for STA devices that support emergency preparedness communication services (EPCS);
receiving, from a STA device that supports EPCS, an association request frame transmitted based on the EDCA parameter set; and
transmitting, to the STA device, an association response frame in response to the association request frame.

2. The AP device of claim 1, wherein the EDCA parameter set provides higher priority for the STA device to transmit the association request frame, relative to a STA device that does not support EPCS.

3. The AP device of claim 1, wherein the association response frame is transmitted with higher priority than an association response frame transmitted to a STA device that does not support EPCS.

4. The AP device of claim 1, wherein the processor is further configured to cause:
prior to the transmitting the frame including the EDCA parameter set, receiving, from the STA device, a probe request frame including information indicating that the STA device supports EPCS; and
the frame including the EDCA parameter set is a probe response frame.

5. The AP device of claim 4, wherein the processor is further configured to cause:
receiving, from the STA device, an authentication request frame transmitted based on the EDCA parameter set; and
transmitting, to the STA device, an authentication response frame in response to the authentication request frame.

6. The AP device of claim 5, wherein the processor is further configured to cause:
transmitting, to the STA device, a disassociation frame based on a determination that the STA device does not support EPCS.

7. The AP device of claim 1, wherein the processor is further configured to cause:
transmitting, to the plurality of STA devices, a discovery frame to facilitate STA devices that support EPCS in discovering the AP device.

8. The AP device of claim 1, wherein the frame including the EDCA parameter set includes information that identifies a time interval during which only STA devices that support EPCS are capable of transmitting a frame.

9. A station (STA) device for facilitating communication in a wireless network, comprising:
a memory; and
a processor coupled to the memory, the processor configured to cause:
receiving, from an access point (AP) device, a frame including an enhanced distributed channel access (EDCA) parameter set that provides prioritized access to a wireless medium for STA devices that support emergency preparedness communication services (EPCS);
transmitting, to the AP device, an association request frame based on the EDCA parameter set; and
receiving, from the AP device, an association response frame in response to the association request frame.

10. The STA device of claim 9, wherein the EDCA parameter set provides higher priority for the STA device to transmit the association request frame, relative to a STA device that does not support EPCS.

11. The STA device of claim 9, wherein the processor is further configured to cause:
prior to the receiving the frame including the EDCA parameter set, transmitting, to the AP device, a probe request frame including information indicating that the STA device supports EPCS; and
the frame including the EDCA parameter set is a probe response frame.

12. The STA device of claim 11, wherein the processor is further configured to cause:
transmitting, to the AP device, an authentication request frame based on the EDCA parameter set; and
receiving, from the AP device, an authentication response frame in response to the authentication request frame.

13. The STA device of claim 12, wherein the processor is further configured to cause:
receiving, from the AP device, a disassociation frame based on a determination that the STA device does not support EPCS.

14. The STA device of claim 9, wherein the processor is further configured to cause:
receiving, from the AP device, a discovery frame to facilitate the STA device in discovering the AP device.

15. A method performed by an access point (AP) device, the method comprising:
transmitting, to a plurality of station (STA) devices, a frame including an enhanced distributed channel access (EDCA) parameter set that provides prioritized access to a wireless medium for STA devices that support emergency preparedness communication services (EPCS);
receiving, from a STA device that supports EPCS, an association request frame transmitted based on the EDCA parameter set; and
transmitting, to the STA device, an association response frame in response to the association request frame.

16. The method of claim 15, wherein the EDCA parameter set provides higher priority for the STA device to transmit the association request frame, relative to a STA device that does not support EPCS.

17. The method of claim 15, wherein the association response frame is transmitted with higher priority than an association response frame transmitted to a STA device that does not support EPCS.

18. The method of claim 15, wherein:
the method further comprises prior to the transmitting the frame including the EDCA parameter set, receiving, from the STA device, a probe request frame including information indicating that the STA device supports EPCS; and
the frame including the EDCA parameter set is a probe response frame.

19. The method of claim 18, wherein the method further comprises:
receiving, from the STA device, an authentication request frame transmitted based on the EDCA parameter set; and
transmitting, to the STA device, an authentication response frame in response to the authentication request frame.

20. The method of claim 19, wherein the method further comprises:
transmitting, to the STA device, a disassociation frame based on a determination that the STA device does not support EPCS.
